(19) United States
(12) Patent Application Publication
(10) Pub. No.: US 2005/0061570 A1
(43) Pub. Date: Mar. 24, 2005

(54) Four-directional forklift truck

(76) Inventors: Martin McVicar, County Monaghan (IE); Robert Moffett, County Monaghan (IE)

Correspondence Address: Timothy A Flory;Van Dyke Gardner Kinn & Burkhart, 2851 Charlevoix Drive SE, Post Office Box 888695, Grand Rapids, MI, 49588-8695, US

(21) Appl. No.: 10/500,643

(22) PCT Filed: Jan. 2, 2002
(86) PCT No.: PCT/IE02/00004

(51) Int. Cl. B60K 17/14

(52) U.S. Cl. 180/308

(57) ABSTRACT

A four-directional forklift truck comprising a chassis 10 having two front wheels 12L, 12R and one rear wheel 14. A respective hydrostatic motor 18 drives each wheel selectively in either one of two opposite directions of rotation. The truck includes control means for placing the truck in a carousel mode wherein the three wheels are set at respective steering angles in which their axes of rotation A1, A2, A3 intersect at substantially common vertical axis C equidistant from each wheel and all three wheels are driven. A switchover valve 30, which is connected between one of the front wheels 12R and a hydraulic power supply 22 and is actuated in sideways mode, is de-actuated in carousel mode.

### FIELD OF THE INVENTION

This invention relates to a four-directional forklift truck, i.e. a forklift truck capable of being driven in forward and reverse directions (standard mode) and also in left and right sideways directions (sideways mode). In particular, it relates to a three-wheel forklift truck with all-wheels driven.

### BACKGROUND TO THE INVENTION

In addition to operation in the standard and sideways modes referred to above, it is also desirable to be able to operate such a truck in carousel mode, i.e. where it rotates substantially on the spot.

However, due to limitations in existing three-wheel drive machines, especially those using hydrostatic motors to drive the wheels, up to the present time manufacturers have had to accept a large turning radius centred around the single rear drive wheel. Alternatively they have tried to convert the machine into a two-wheel drive when operating in carousel mode by disconnecting the drive to one of the front wheels. Alternatively they have tried to convert the machine to one-wheel drive by disconnecting the drive to the two front wheels.

In either case this has required the extra cost of providing disconnection valves in one or more of the hydraulic circuits to the wheel motor(s). Also, when hydraulic fluid is disengaged from one or more wheel motor(s) in a hydrostatic circuit, cavitation can occur in the non-driven motor(s) when the other wheel(s) are being driven.

### SUMMARY OF THE INVENTION

The invention provides a four-directional forklift truck comprising a chassis having two front wheels and one rear wheel, each wheel being directionally adjustable by rotation about a substantially vertical axis, and a respective motor for driving each wheel selectively in either one of two opposite directions of rotation, wherein the truck is operable in a carousel mode wherein the three wheels are set at respective directions in which their axes of rotation intersect at a substantially common vertical axis equidistant from each wheel and all three wheels are driven, whereby the truck rotates substantially about the said common vertical axis.

In a preferred embodiment the invention provides a four-directional forklift truck comprising:
a chassis having two front wheels and one rear wheel, each wheel being directionally adjustable by rotation about a substantially vertical axis,
a respective hydrostatic motor for driving each wheel selectively in either one of two opposite directions of rotation, each motor having first and second hydraulic fluid inlet ports, the application of hydraulic fluid under pressure to the first inlet port driving the wheel in one direction and the application of hydraulic fluid under pressure to the second inlet port driving the wheel in the opposite direction, and
a hydraulic circuit comprising a source of hydraulic fluid under pressure having first and second fluid supply ports, the hydraulic fluid under pressure being selectively supplied at the first or second supply port, the first and second inlet ports of at least one front wheel being coupled to the first and second supply ports via a respective selectively actuable switchover valve and the first and second inlet ports of the other wheel(s) being non-switchably coupled to the first and second supply ports respectively,
wherein when the truck is operated in standard mode the switchover valve is not actuated, the front wheels are set substantially in the front-to-rear direction of the chassis, and the rear wheel is steerable to turn the truck in the required direction, and
wherein when the truck is operated in sideways mode the switchover valve is actuated, the rear wheel is set substantially normal to the front-to-rear direction of the chassis, and the front wheels are steerable simultaneously in opposite directions of rotation,
the truck further being operable in a carousel mode in which the switchover valve is not actuated, the three wheels are set at respective directions in which their axes of rotation intersect at a substantially common vertical axis equidistant from each wheel, and all three wheels are driven, whereby the truck rotates substantially about the said common vertical axis.

### BRIEF DESCRIPTION ON THE DRAWINGS

Embodiments of the invention will now be described, by way of example, with reference to the accompanying drawings, in which:

FIG. 1 is a schematic plan view of a forklift truck according to a first embodiment of the invention, operating in standard mode;

FIG. 2 is a schematic plan view of the truck of FIG. 1 operating in sideways mode;

FIG. 3 is a schematic plan view of the truck of FIG. 1 rotating anti-clockwise in carousel mode;

FIG. 4 is a schematic plan view of the truck of FIG. 1 rotating clockwise in carousel mode;

FIG. 5 is a schematic plan view of a forklift truck according to a second embodiment of the invention, operating in standard mode;

FIG. 6 is a schematic plan view of the truck of FIG. 5 operating in sideways mode;

FIG. 7 is a schematic plan view of the truck of FIG. 5 rotating anti-clockwise in carousel mode; and

FIG. 8 is a schematic plan view of the truck of FIG. 5 rotating clockwise in carousel mode.

### DESCRIPTION OF THE PREFERRED EMBODIMENTS

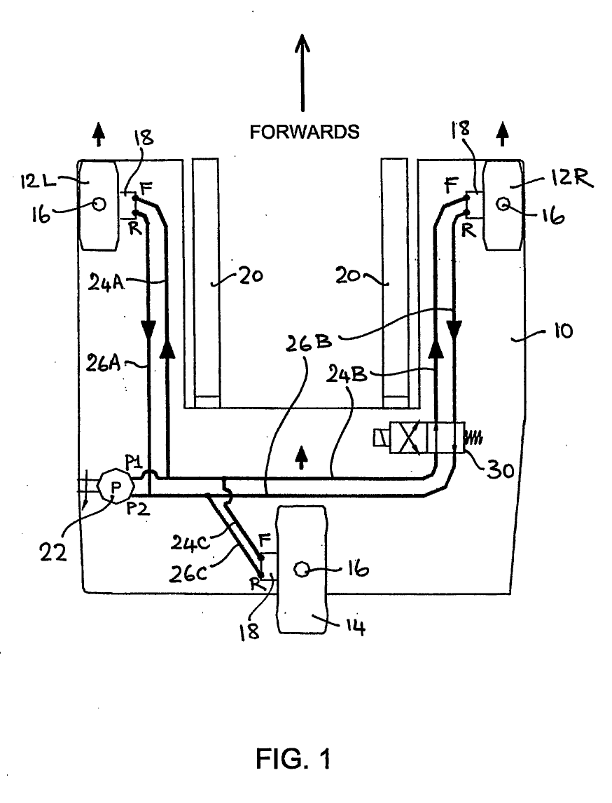

Referring to FIG. 1, a three-wheel, four-directional forklift truck with all-wheel drive comprises a chassis 10 having left and right front ground wheels 12L, 12R respectively and a single rear ground wheel 14 disposed centrally between, but rearwardly displaced, relative to the front wheels. All three wheels are directionally adjustable by rotation about respective substantially vertical axes 16. Such rotation is effected by respective hydraulic cylinders associated with each wheel. This is well-known and is therefore not shown. The chassis carries a conventional mast (not shown) and lift forks 20.

Each wheel 12L, 12R and 14 can be driven selectively in either one of two opposite directions of rotation by a respective hydrostatic motor 18. Each motor has hydraulic fluid inlet ports F and R respectively, the application of hydraulic fluid under pressure to the inlet port F driving the wheel in a forward direction (indicated by the arrows in FIG. 1) and the application of hydraulic fluid under pressure to the inlet port R driving the wheel in the reverse direction. The motors 18 are driven by a hydraulic circuit which includes a pump 22 for supplying hydraulic fluid under pressure selectively to fluid supply ports P1 and P2 respectively, the supply ports being connected to the motors 18 by hydraulic lines 24A, 24B, 24C, 26A, 26B and 26C.

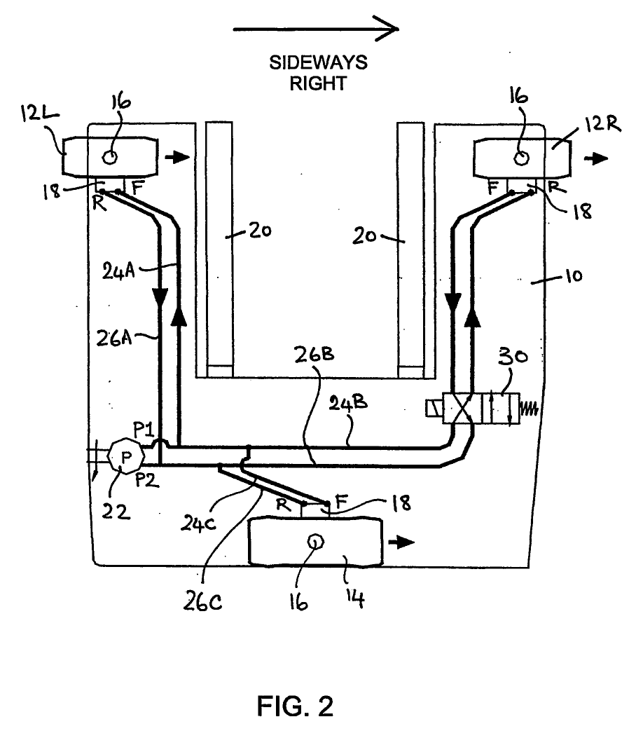

As seen in FIG. 1, in this embodiment the inlet ports F, R of the right front wheel 12R are coupled to the supply ports P1; P2 of the pump 22 via a selectively actuable switchover valve 30, whereas the inlet ports F, R of each of the other two wheels 12L, 14 are non-switchably coupled to the supply ports P1, P2 respectively. The operation of the valve 30 is such that when the valve is not actuated (as shown in FIG. 1) the inlet ports F, R of the right front wheel 12R are connected to the supply ports P1, P2 respectively, whereas when the valve is actuated (FIG. 2) the hydraulic lines 24B, 26B cross over so that the inlet ports F, R of the wheel 12R are connected to the supply ports P2, P1 respectively. The valve 30 can be actuated and de-actuated hydraulically, mechanically, electro-magnetically or in any other suitable manner.

When the truck is configured for standard (i.e. forward/reverse) operation, FIG. 1, the valve 30 is not actuated and the rear wheel 14.is set substantially in the front-to-rear direction of the chassis 10. In order to drive the truck in the forward direction, fluid under pressure is supplied by the pump 22 to the supply port P1 and thus to the hydraulic lines 24A, 24B and 24C. Therefore, the fluid pressure is applied to the inlet port F of each wheel motor 18, and all three wheels are driven in a forward direction. In order to drive the truck in the reverse direction (not shown), the fluid under pressure supplied by the pump 22 is simply switched from the supply port P1 to the supply port P2 and is thus removed from the inlet ports F and applied to the inlet ports R via the hydraulic lines 26A, 26B and 26C. The switchover of the hydraulic fluid under pressure between the supply ports P1 and P2 is effected under operator control. In standard mode, in both forward and reverse drive directions, the front wheels 12L, 12R of the truck are turned to the front-to-rear direction and locked in position, the rear wheel 14 can be steered by the operator in conventional manner to steer the vehicle, i.e. the rear wheel can turn clockwise or anti-clockwise about its axis 16 as the steering wheel (not shown) is rotated one way or the other.

In order to configure the truck for operation in sideways mode, FIG. 2, the rear wheel is turned through 90° and locked, and the front wheels are likewise turned inwards (i.e., in plan view the wheel 12L is rotated clockwise about its axis 16 and the wheel 12R anti-clockwise about its axis 16), each through 90°, so that they lie in line and parallel with the rear wheel (i.e. substantially normal to the front-to-rear direction of the chassis). Also, the valve 30 is actuated so that the hydraulic lines 24B, 26B cross over whereby the inlet ports F, R of the wheel 12R are connected to the supply ports P2, P1 respectively. These actions may be effected automatically by the vehicle control system (not shown) when the operator selects sideways mode, for example, by pressing a button located in the cab.

Now, if the hydraulic fluid under pressure is supplied to the port P1 all three wheels, and hence the truck, will drive to the right, as indicated by the arrows in FIG. 2. Alternatively, if the hydraulic fluid under pressure is supplied to the port P2, all three wheels will drive to the left (not shown). In sideways mode, in both left and right drive directions, the front wheels 12L, 12R of the truck can be steered by the operator, to change the directional course of the truck. Here, both front wheels rotate simultaneously in opposite directions, i.e. when one rotates clockwise about its axis 16 the other rotates anti-clockwise about its axis 16, and vice-versa.

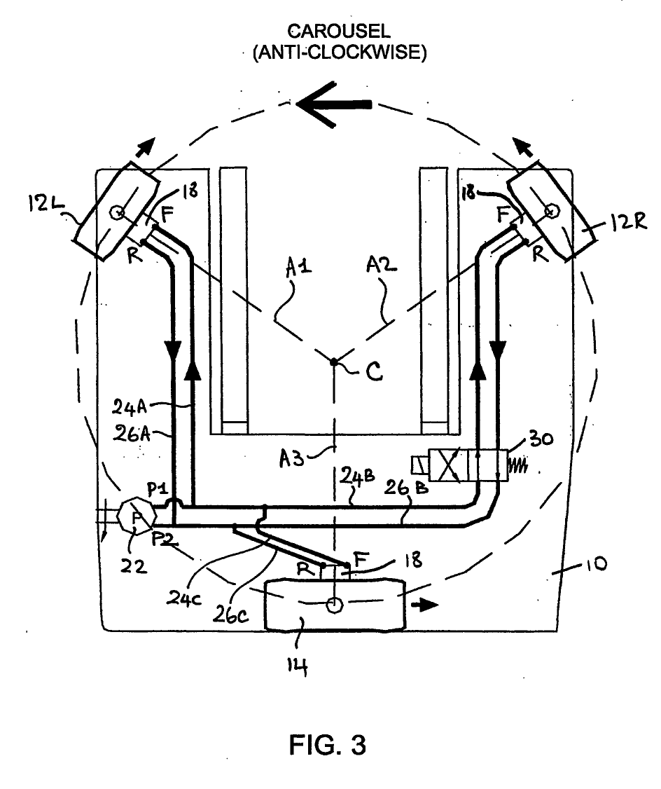

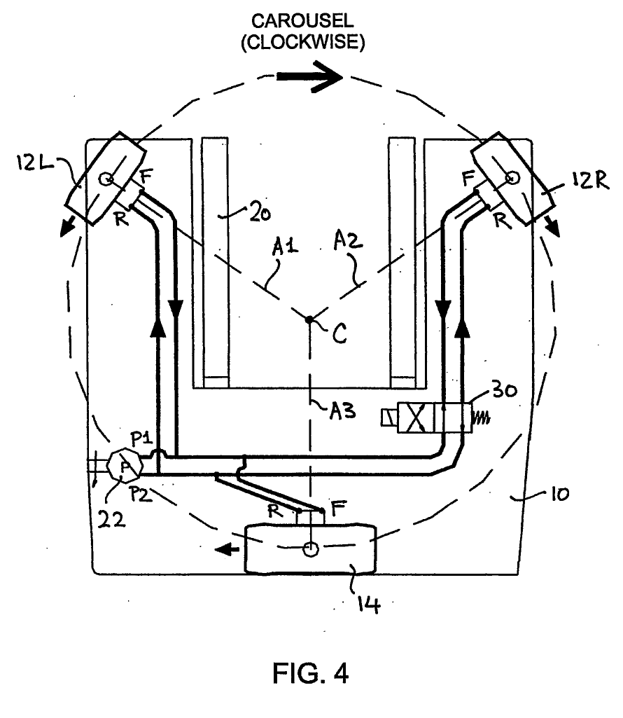

The truck may also be configured for operation in carousel mode, FIGS. 3 and 4. In carousel mode, the three wheels 12L, 12R and 14 are set at respective directions in which their axes of rotation A1, A2, A3 intersect at a substantially common vertical axis C equidistant from each wheel. Also, the valve 30 is not actuated. The vehicle control system can place the truck automatically in carousel mode upon selection of such mode by the operator (not shown), for example, by pressing a button located in the cab.

Alternatively or additionally, the truck can be made to enter carousel mode from sideways mode by the operator turning the front wheels 12L, 12R sufficiently that the two front wheels assume the relationship shown in FIGS. 3 and 4, as detected by for example, a sensor attached to one of the front wheels. The sensor can be a proximity switch, a hydraulic switch or any other suitable mechanism for determining when the wheel has turned to a predetermined angle, and it may not be a wheel mounted sensor.

Then, if it is desired to rotate the truck in an anticlockwise direction about the axis C, FIG. 3, hydraulic fluid under pressure is supplied to the port P1. This fluid pressure is applied via the lines 24A, 24B and 24C to the inlet port F of each wheel so that the wheels are driven in the directions indicated by the arrows.

It will be seen that although the wheels 12R and 14 rotate in the correct direction to drive the truck anticlockwise about the axis C, the wheel 12L tends to drive the truck in the opposite direction. However, the combined torque of the wheels 12R and 14 substantially exceeds that of the wheel 12L so that the wheel 12L is overcome and the truck as a whole rotates anticlockwise about the vertical axis C.

If it is desired to rotate the truck in a clockwise direction about the axis C, FIG. 4, the hydraulic fluid under pressure is switched from the port P1 to the port P2. Now the fluid pressure is applied to the inlet port R of each wheel so that all three wheels rotate in the opposite direction to that shown in FIG. 3, i.e., the wheels are driven in the directions of the arrows shown in FIG. 4. Again it will be seen that combined torque of two of the wheels 12R and 14 overcomes that of the single wheel 12L tending to drive the truck in an anticlockwise direction so that the truck as a whole rotates in a clockwise direction about the axis C.

In both anticlockwise and clockwise rotation all three wheels are driven at all times, thereby overcoming the cavitation problem referred to earlier. Also, this embodiment takes advantage of the valve 30, which is already present to provide sideways working, so that additional valves are not necessary.

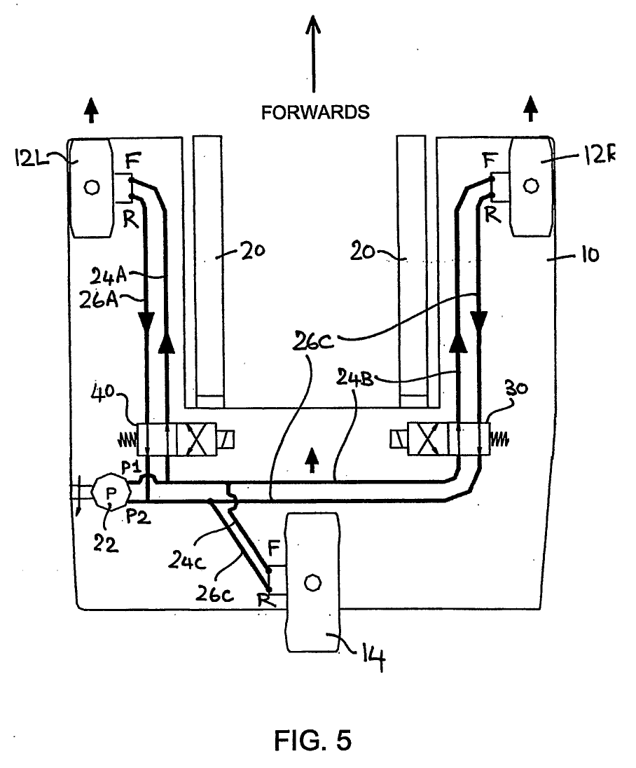

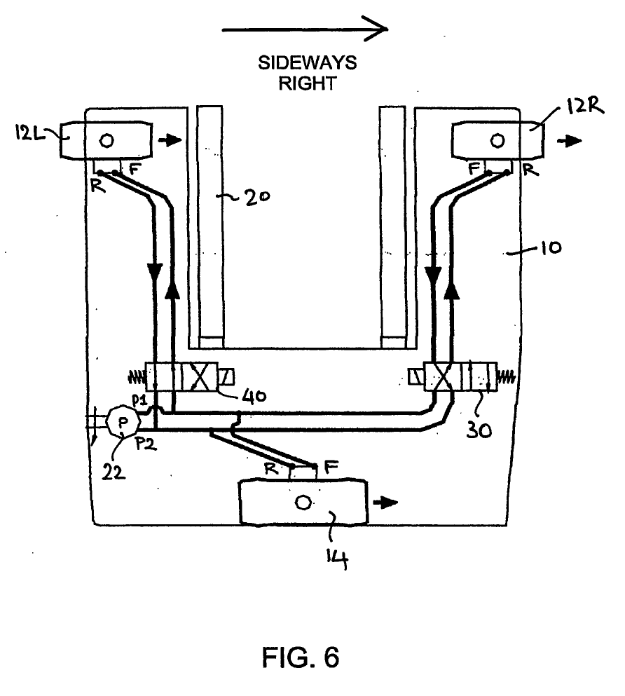

A second embodiment of the invention, FIGS. 5 to 8, is the same as the first except that a further selectively actuable switchover valve 40 is connected between the inlet ports F, R of the left front wheel 12L and the supply ports P1, P2 of the pump 22. In standard and sideways modes, FIGS. 5 and 6, the valve 40 is not actuated and the truck operates as described for the first embodiment.

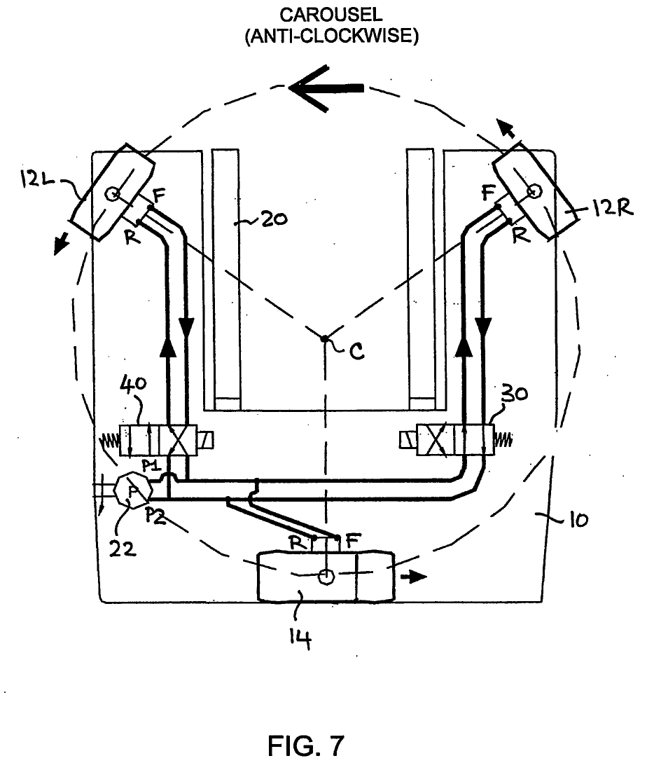

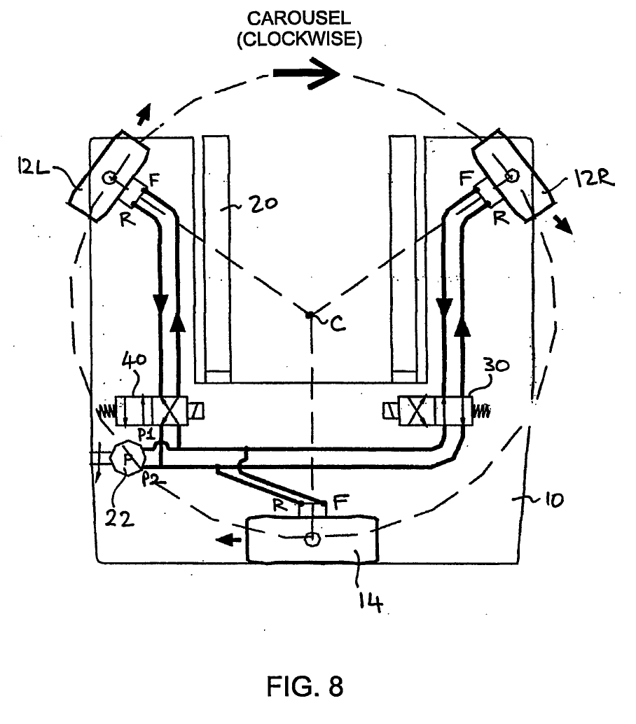

However, in carousel mode, FIGS. 7 and 8, the valve 40 is actuated so that the left front wheel 12L, which in the first embodiment acted against the desired direction of rotation of the truck, now drives the truck in the same direction as the other two wheels.

The invention is applicable to wheels driven by electric motors as well as those driven by hydrostatic motors.

The invention is not limited to the embodiments described herein and may be modified or varied without departing from the scope of the invention.

1. A four-directional forklift truck comprising a chassis having two front wheels and one rear wheel, each wheel being directionally adjustable by rotation about a substantially vertical axis, and a respective motor for driving each wheel selectively in either one of two opposite directions of rotation, wherein the truck is operable in a carousel mode wherein the three wheels are set at respective directions in which their axes of rotation intersect at a substantially common vertical axis equidistant from each wheel and all three wheels are driven, whereby the truck rotates substantially about the said common vertical axis.

2. A forklift truck as claimed in claim 1, wherein each wheel motor is a hydrostatic motor, the truck further including a hydraulic circuit for supplying hydraulic fluid under pressure to each motor.

3. A forklift truck as claimed in claim 2, wherein each motor has first and second hydraulic fluid inlet ports, the application of hydraulic fluid under pressure to the first inlet port driving the wheel in one direction and the application of hydraulic fluid under pressure to the second inlet port driving the wheel in the opposite direction, and wherein the hydraulic circuit comprises a source of hydraulic fluid under pressure having first and second fluid supply ports, the hydraulic fluid under pressure being selectively supplied at the first or second supply port.

4. A forklift truck as claimed in claim 3, in which the first and second inlet ports of at least one front wheel are coupled to the first and second supply ports via a respective selectively actuable switchover valve, and in which the first and second inlet ports of the other wheel(s) are non-switchably coupled to the first and second supply ports respectively, wherein when the truck is operated in standard mode the switchover valve is not actuated, when the truck is operated in sideways mode the switchover valve is actuated, and when the truck is operated in carousel mode the switchover valve is not actuated.

5. A forklift truck as claimed in claim 4, wherein the first and second inlet ports of only the said one front wheel are coupled to the first and second supply ports via a switchover valve whereby in the carousel mode the rear wheel and the said one front wheel drive the truck about the common vertical axis in a given direction of rotation against the action of the other front wheel tending to drive the truck in the other direction of rotation.

6. A forklift truck as claimed in claim 4, wherein the first and second inlet ports of the other front wheel are coupled to the first and second supply ports via a respective further switchover valve, the further switchover valve not being actuated in the standard and sideways modes but being actuated in carousel mode, whereby in the carousel mode all three wheels drive the truck about the common vertical axis in a given direction of rotation.

7. A forklift truck as claimed in claim 4, wherein the truck enters the carousel mode from sideways mode by de-actuating the switchover valve when the front wheels are steered through a sufficient angle to set the three wheels at respective directions in which their axes of rotation intersect at the said substantially common vertical axis.

8. A four-directional forklift truck comprising:
a chassis having two front wheels and one rear wheel, each wheel being directionally adjustable by rotation about a substantially vertical axis,
a respective hydrostatic motor for driving each wheel selectively in either one of two opposite directions of rotation, each motor having first and second hydraulic fluid inlet ports, the application of hydraulic fluid under pressure to the first inlet port driving the wheel in one direction and the application of hydraulic fluid under pressure to the second inlet port driving the wheel in the opposite direction, and
a hydraulic circuit comprising a source of hydraulic fluid under pressure having first and second fluid supply ports, the hydraulic fluid under pressure being selectively supplied at the first or second supply port, the first and second inlet ports of at least one front wheel being coupled to the first and second supply ports via a respective selectively actuable switchover valve and the first and second inlet ports of the other wheel(s) being non-switchably coupled to the first and second supply ports respectively,
wherein when the truck is operated in standard mode the switchover valve is not actuated, the front wheels are set substantially in the front-to-rear direction of the chassis, and the rear wheel is steerable to turn the truck in the required direction, and
wherein when the truck is operated in sideways mode the switchover valve is actuated, the rear wheel is set substantially normal to the front-to-rear direction of the chassis, and the front wheels are steerable simultaneously in opposite directions of rotation,
the truck further being operable in a carousel mode in which the switchover valve is not actuated, the three wheels are set at respective directions in which their axes of rotation intersect at a substantially common vertical axis equidistant from each wheel, and all three wheels are driven, whereby the truck rotates substantially about the said common vertical axis.

9. A forklift truck as claimed in claim 5, wherein the truck enters the carousel mode from sideways mode by de-actuating the switchover valve when the front wheels are steered through a sufficient angle to set the three wheels at respective directions in which their axes of rotation intersect at the said substantially common vertical axis.

10. A forklift truck as claimed in claim 6, wherein the truck enters the carousel mode from sideways mode by de-actuating the switchover valve when the front wheels are steered through a sufficient angle to set the three wheels at respective directions in which their axes of rotation intersect at the said substantially common vertical axis.
